(19) United States
(12) Patent Application Publication
(10) Pub. No.: US 2020/0299843 A1
(43) Pub. Date: Sep. 24, 2020

(54) METHOD OF APPLYING AN ANTIMICROBIAL SURFACE COATING TO A SUBSTRATE

(71) Applicant: University of the Witwatersrand, Johannesburg, Johannesburg (ZA)

(72) Inventors: Ionel BOTEF, Johannesburg (ZA); Michael David Ivan LUCAS, Johannesburg (ZA); Sandy van VUUREN, Roodepoort (ZA)

(73) Assignee: University of the Witwatersrand, Johannesburg, Johannesburg (ZA)

(21) Appl. No.: 16/652,389

(22) PCT Filed: Sep. 25, 2018
(86) PCT No.: PCT/IB2018/057488

§ 371 Date: Mar. 30, 2020

(30) Foreign Application Priority Data
Sep. 29, 2017 (ZA) 2017/06586

(51) Int. Cl. C23C 24/04; A01N 59/20; A01N 59/06

(52) U.S. Cl. CPC C23C 24/04; B33Y 10/00; A01N 59/06; A01N 59/20

(57) ABSTRACT

THIS invention relates to a method of applying an antimicrobial surface coating to a substrate, and more particularly to a method of applying an antimicrobial surface coating to a polymeric substrate manufactured by way of additive manufacturing. The method includes the steps of providing a body to be coated, the body having a surface area and cold spraying an antimicrobial metal powder on at least part of the surface area of the body so as to form an antimicrobial coating on the body. The method is characterized in that the body is made from a polymeric material by way of an additive manufacturing process.

### BACKGROUND TO THE INVENTION

THIS invention relates to a method of applying an antimicrobial surface coating to a substrate, and more particularly to a method of applying an antimicrobial surface coating to a polymeric substrate manufactured by way of additive manufacturing.

A hospital-acquired infection (HAI), also known as a nosocomial infection, is an infection that is acquired in a hospital or other healthcare facility, for example a nursing home, rehabilitation facility, outpatient clinic, or other clinical setting. Infection is spread to a susceptible patient in the clinical setting by various means. Health care staff and patients can spread infection in combination with, or in addition to the presence of, contaminated equipment and structures, bed linens, or air droplets. The infection can originate from many sources, including the outside environment, another infected patient, staff that may be infected, or in some cases, the source of the infection cannot be determined. It has been shown that environmental contaminants in hospitals, including surface contact sites, contribute significantly to the spread of HAI's.

An antimicrobial surface is a surface that contains an antimicrobial agent that inhibits the ability of microorganisms to grow on the surface of a material. Antimicrobial coatings may also have the ability to actively kill microorganisms, and they may actively affect cell structure and cellular processes, thereby inducing cell death. The purpose of antimicrobial surfaces is to mitigate the risk of HAIs, and coatings including metals such as copper, silver and zinc have been observed to have very good antimicrobial activity against bacteria. Antimicrobial coatings can be applied in many different ways, depending on, inter alia, the kind of substrate to which it is applied.

The manufacturing industry has been revolutionized by the advent of additive manufacturing. Additive manufacturing (AM) refers to processes used to create a three dimensional object in which layers of material are formed under computer control to create an object. Objects can be of almost any shape or geometry and are produced using digital model data from a 3D model or another electronic data source such as a STL file. Thus, unlike material removed from a stock in the conventional machining process, 3D printing or AM builds a three-dimensional object from computer-aided design (CAD) model or an AMF file by successively adding material in a layer by layer process. Additive manufacturing opens up many new options and design benefits when compared to traditional manufacturing techniques. The design-for-function, as opposed to design-for-manufacture, philosophy presents a fundamental paradigm shift, allowing for increased part complexity tailored to particular design's requirements. It also allows for ease of customization, as a design for additive manufacturing need not adhere to the traditional end goal of mass production in order to be financially and practically viable. It follows that the use of additive manufacturing is also desirable insofar as the manufacture of medical devices and health care related articles are concerned.

Fused deposition modelling (FDM) is one form of additive manufacturing in which a selected printing material is laid down in layers to form a desired three dimensional object. Various materials can be used in FDM, including but not limited to acrylonitrile butadiene styrene (ABS), polylactic acid (PLA) and polycarbonate (PC). The materials all have different trade-offs between strength, surface finish, accuracy of printing and temperature properties.

A challenge associated with the use of articles manufactured using FDM, and in particular articles manufactured from ABS or PLA, is that conventional methods of applying an antimicrobial surface coating to such articles have proven to be problematic. Metal deposition techniques exist for various applications, yet are not without limitations. Physical vapour deposition (PVD) and chemical vapour deposition (CVD) techniques have high equipment and processing costs, as well as workpiece size limitations. Electroplating results in a low adhesive force and is not environmentally friendly, and thermal spray techniques can lead to erosive thermal effects.

Cold spray is a solid state deposition technique, utilizing a supersonic converging-diverging nozzle to accelerate powder particles in a carrier gas such that impact on a substrate results in particle deposition, adequate adhesion and subsequent layer build-up. The process is considered a low temperature process, since the operating temperature remains below that of the melting point of the feedstock powder material. Spray conditions are controlled through careful selection of the process parameters, namely: operating temperature and pressure, nozzle standoff distance and transverse speed, powder feed rate, nozzle step distance (defined as the perpendicular offset distance between two parallel cold spray runs), spray powder (material, size and morphology) and the carrier gas (air, nitrogen or helium).

Cold spray has received particular interest over the past few decades, from studies exploring the use of, and mechanisms behind cold spray surface coatings to theoretical modelling approaches. Using cold spray copper, zinc and tin were unsuccessfully deposited onto carbon fibre-reinforced polyetheretherketone (PEEK) substrates (PEEK450CA30). This was, however, only possible when aluminium was used as a binding layer and copper could not be deposited directly onto the PEEK substrate. [Zhou, X. L., Chen, A. F., Liu, J. C., Wu, X. K. and Zhang, J. S. 2011. Preparation of Metallic Coatings on Polymer Matrix Composites by Cold Spray, Surface & Coatings Technology, 206, pp 132-136]. Lupoi and O'Neil [Lupoi, R. and O'Neill, W. 2010. Deposition of Metallic Coatings on Polymer Surfaces Using Cold Spray, Surface Coatings & Technology, 205, pp 2167-2173.] observed a predominant erosive effect for copper cold spray onto a PC/ABS substrate, thus again providing no obvious solution for applying a copper coating to an ABS or PC substrate. The study indicated that the excessive energy associated with the process resulted in surface erosion rather than coating build up. Although Lupoi and O'Neill disclose the basic idea of depositing copper onto an ABS substrate using a cold spray process, they could not provide a solution as to how this can be achieved, and also do not provide any obvious guidance as to how this problem is to be solved. In effect, Lupoi and O'Neill teaches away from using a cold spraying process onto polymer substrates, as no solution to their failed attempt is proposed.

Deposition of copper via cold spraying on a polymer is disclosed in a very broad sense in US2011/0206817 (“Arnold”). The specific application of the copper coating onto 3D printed material (or an object made in an additive manufacturing process) and in particular ABS, PLA and PC, is however not specifically disclosed. Arnold therefore alludes to the broad idea of applying a copper coating to a polymer, but fails to teach how the principle will be put into effect in cases where the substrate is in the form of the 3D printed materials as set out above. Arnold merely provides a wide range for cold spray parameters, which may happen to contain a parameter subset that is suitable for use with 3D printed materials, but which is not identified. Arnold also doesn't disclose all pertinent parameters, let alone their ideal values. The Arnold disclosure makes no mention of nozzle transverse velocity, nozzle geometry or the nozzle step distance, which may not be inferred from other parameter values.

Small parameter variations have large implications for the results of the cold spray process. Parameter set selection is therefore a critical step to successful coating generation and one which is not disclosed in any detail in the Arnold patent. It will be appreciated that cold spray parameter selection is not a straightforward process, which would explain why Arnold only discloses a very broad regime in which cold spraying takes place. Careful design and parameter optimisation is required for a specific application in order to achieve quality surface coatings—especially on polymeric substrate materials. In summary, Arnold discloses a broad genus, but fails to disclose a species suitable for use in an additive manufacturing regime.

It is accordingly an object of the invention to provide a method of applying an antimicrobial surface coating to a substrate that will, at least partially, alleviate the above shortcomings.

It is also an object of the invention to provide a method of applying an antimicrobial surface coating to a substrate which will be a useful alternative to existing methods of applying an antimicrobial surface coating to substrates.

### SUMMARY OF THE INVENTION

According to the invention there is provided a method of manufacturing a coated article, the method including the steps of:
providing a body to be coated, the body having a surface area;
cold spraying an antimicrobial metal powder on at least part of the surface area of the body so as to form an antimicrobial coating on the body;
characterized in that the body is made from a polymeric material by way of an additive manufacturing process.

There is provided for the additive manufacturing process to be in the form of 3D printing or fused deposition modelling.

The polymeric material may be selected from the group including ABS, PLA and PC, and other suitable materials. In a preferred embodiment the polymeric material is ABS.

There is provided for the antimicrobial metal powder to be selected from the group including copper, silver, zinc, a combination thereof, or a copper-aluminium-alumina blend.

A further feature of the invention provides for at least one of an operating pressure, an operating temperature, a nozzle standoff distance, a nozzle transverse speed, a powder feed rate and a step distance to be controlled.

The operating pressure may be between 0.6 and 1 MPa, preferably between 0.75 and 0.85 MPa.

The operating temperature may be less than 500° C., preferably between 100 and 300° C., and more preferably between 190 and 210° C.

The nozzle standoff distance may be between 5 and 30 mm, preferably between 5 and 15 mm.

The nozzle transverse speed may be between 5 and 25 mm/s, preferably between 10 and 15 mm/s.

The powder feed rate may be between 20 and 50%, preferably between 25 and 35%.

The step distance may be between 2 and 6 mm, preferably between 4 and 6 mm.

According to a further aspect of the invention there is provided a coated article including:
a polymeric body made by way of an additive manufacturing process, the body having a surface area; and
an anti-microbial coating formed on at least part of the surface area.

There is provided for the antimicrobial coating to be in the form of a metal coating.

There is provided for the metal coating to be selected from the group including copper, silver, zinc, a combination thereof, or a copper-aluminium-alumina blend.

According to a still further aspect of the invention there is provided use of an antimicrobial coating on a polymeric body in order to provide antimicrobial activity in both a wet, diffusive environment and more preferably a dry, touch-contact environment.

### BRIEF DESCRIPTION OF THE DRAWINGS

A preferred embodiment of the invention is described by way of a non-limiting example, and with reference to the accompanying drawings in which:

FIG. 1 is a perspective view of a sample of a 3D printed ABS cube with an antimicrobial surface coating applied thereto in accordance with the invention;

FIG. 2 is a schematic view showing the cold spray setup and substrate orientation used to produce the cube of FIG. 1;

FIG. 3 depicts two potential surface geometries that may be used when exercising the method of this invention;

FIG. 4 shows an EDX surface analysis of the cold sprayed copper coating on the 3D printed ABS;

FIG. 5 shows a SEM cross-sectional image of the cold sprayed copper coating on the 3D printed ABS;

FIG. 6a shows a zone of inhibition for a copper cold spray coating on a 3D printed substrate with a smooth surface topography;

FIG. 6b shows a zone of inhibition for a copper cold spray coating on a 3D printed substrate with raised hemispherical dots as shown in FIG. 3;

FIG. 6c shows a zone of inhibition for a copper cold spray coating on a 3D printed substrate with sunken hemispherical dots as shown in FIG. 3;

FIG. 7a shows a first control sample including a Neomycin positive control disc;

FIG. 7b shows a second control sample comprising 3D printed ABS without a coating;

FIG. 7c shows a third control sample comprising a stainless steel substrate without a coating;

FIG. 7d shows a fourth control sample in the form of a pure copper body;

FIG. 8 is a schematic diagram showing how the zone of inhibition is determined during testing;

FIG. 9 is a graph showing the average zone of inhibition for cold spray coatings against bacterial and fungal pathogens;

FIG. 10 is a graph showing the average zone of inhibition for silver containing coatings against bacterial and fungal pathogens;

FIG. 11 is a graph showing the average zone of inhibition for best performing cold spray coatings against resistant microbial strains;

FIG. 12 depicts an annotated graphical representation of the test method employed for dry contact antimicrobial susceptibility testing;

FIG. 13 is a graph showing the CFU/ml per sampling period for a cold spray copper coating on vertically oriented 3D printed ABS against S. aureus (ATCC 25923);

FIG. 14 is a graph showing the CFU/ml per sampling period for a cold spray copper coating on 3D printed ABS (horizontal orientation) against P. aeruginosa (ATCC 27853);

FIG. 15 is a graph showing the CFU/ml per sampling period for a cold spray 50% (w/w) copper-zinc coating on a 3D printed ABS substrate (horizontal print orientation) against C. albicans (ATCC 10231);

FIG. 16 illustrates the vertical and horizontal 3D print orientations referred to in this specification; and

FIG. 17 depicts binary micrographs of three coating types, namely: a copper coating on (a) solid ABS, (b) horizontally oriented 3D printed ABS and on (c) vertically oriented 3D printed ABS.

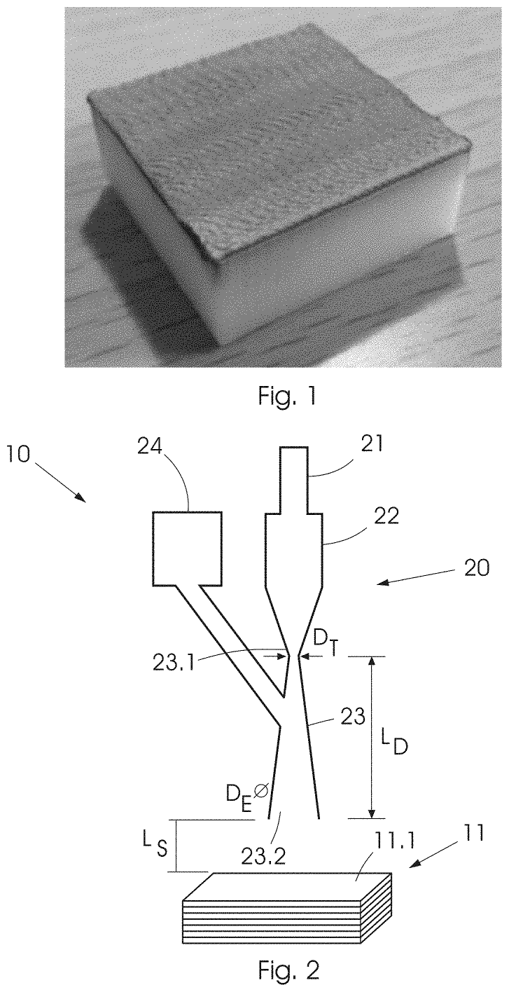

### DESCRIPTION OF TYPICAL APPARATUS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Referring to the drawings, in which like numerals indicate like features, a non-limiting example of a cold spraying setup (FIG. 2) used in exercising the invention is generally indicated by reference numeral 10.

3D printing is an additive manufacturing technique, utilising a programmable robotic end manipulator (not shown), which based on a predefined CAD (Computer Aided Design) design and its STL (STereoLithography) file, builds up a scaled three dimensional object 11 through successive layer deposition. One example of a 3D printer is an uPrint SE 3D printer manufactured by Stratasys. This printer uses Fused Deposition Modelling (FDM) technology and has a maximum component build size of 203×152×152 mm and a layer resolution of 0.254 mm. In one example, the solid 3D printed object 11 shown in FIG. 2 is orientated such that a side 11.1 with a stronger direction and rougher surface finish (perpendicular to the 3D printed layers) is in-line with the cold spray nozzle direction.

Cold spray is a material solid state deposition technique, utilising high pressure and a supersonic converging-diverging nozzle to accelerate spray particles (between 1 μm and 50 μm) such that impact on a substrate results in deposition, adequate bonding and subsequent layer build-up. The process is considered a low temperature coating process, since the temperatures involved are below that of the melting point of the spray powder, thus precluding unwanted thermal effects. Deposition and bonding criteria are based on a number of interrelated parameters, chief of which are the particle impact velocity and the hardness ratio between the spray powder and substrate material respectively. A simplification of a cold spray apparatus, shown in FIG. 2, comprises a compressed air supply line 21, which supplies compressed air (or another suitable working fluid) to a gas pre-heater 22 where the compressed air is pre-heated to a desired temperature. The heated compressed air is then forced through a converging-diverging nozzle 23, at which point a coating material from a coating powder feeder or hopper 24 is also introduced into the compressed air stream, and accelerated through the nozzle 23. The particle/gas stream is accelerated through the nozzle in order for the stream to obtain sufficient velocity in order for the coating material to be deposited onto the surface of the object 11 to be coated.

Some of the geometric variables associated with the process include (shown in FIG. 2, and all in units of mm):
Nozzle length (L_{D});
Nozzle throat diameter (D_{T});
Nozzle exit diameter (D_{E}); and
Nozzle standoff distance (L_{S} or SOD).

The most important variables associated with the process are believed to include:
Operating pressure (MPa);
Operating temperature (° C.);
Nozzle transverse speed (mm/s);
Powder feed rate (%); and
Nozzle standoff distance (mm).

Other significant variables include:
Nozzle length (mm);
Nozzle throat diameter (mm);
Nozzle exit diameter (mm);
Spray gas;
Coating powder;
Coating powder particle size (μm);
Substrate temperature (° C.);
Spray run offset or step distance (mm);
Ambient pressure (KPa); and
Ambient temperature (° C.).

Design Methodology

Cold Spray Model Development

The range of applicability of the cold spray system is far reaching. Its capabilities as a repair and restorative process to its application in precise surface coatings, exemplifies the diverse application in which cold spray may be found and effectively used. The ability to accurately control the cold spray system requires knowledge of the independent and combined effects of the process parameters. Theoretical modelling provides a means of achieving this control.

Parameter selection plays a vital role in achieving an acceptable surface coating. However, it is a known problematic area in cold spray research. The inability to know, before cold spraying, the effect such a parameter set will have on coating quality introduces inefficiencies and design uncertainty. Theoretical modelling aims to reduce this uncertainty with regards to parameter selection in the cold spray process. Theoretical modelling may take the form of a one-dimensional, isentropic gas flow model or a one-dimensional, yet non-isentropic model, or even a two-dimensional model. Some models have attempted to take into account boundary layer effects within the cold spray nozzle. At present, a suitable cold spray parameter set for deposition is usually defined as one in which the particle velocity at nozzle exit exceeds a predefined critical particle impact velocity. Most calculations of critical velocity neglect the substrate material and only consider the effects of spray material, thus limiting the applicability to powder-substrate material combinations of relatively similar properties. Where materials of contrasting properties are used, the influence and subsequent inclusion of such differences is required. Particle depth-of-penetration, includes material property effects of both the powder feedstock material and the substrate material, and is therefore a suitable criterion for parameter set selection.

A mathematical model, based on the integration of one dimensional gas dynamics and a particle impact model, was developed accordingly. Spray gas and powder velocities were calculated and used by a particle impact model to predict particle depth-of-penetration into various substrates. Typically cold spray models define acceptable deposition efficiency as the attainment of a material-specific critical velocity. The developed model, in contrast, makes use of the particle depth-of-penetration as a more appropriate discriminating criterion for deposition between dissimilar materials. Cold spray powder and substrate property variation is consequently taken into account.

Due to the relative softness of the 3D printed substrates, particle embedment was not only expected, but desired, so as to achieve a mechanical entanglement bonding mechanism. In contrary to a metallurgical bond between the impacting spray particles and the substrate, as for typical metal-on-metal cold spraying, a moderate particle embedment in a polymer matrix was desired. Parameter selection was made on this basis: to achieve an embedment of spray particles, such that the first spray layer results in a stronger base onto which subsequent layers may build.

Based on gas dynamic principles and the selected process parameters, the nozzle exit conditions were calculated. Due to the short standoff distance employed in a typical cold spray process, the deceleration of spray particles, between the nozzle exit and the substrate, was assumed negligibly small. The impact conditions were therefore evaluated based on the flow conditions at the nozzle exit. Equation 1, suggested by R. C. Dykhuizen et al. [Dykhuizen, R. C. and Smith, M. F. 1998. Gas Dynamic Principles of Cold Spray, Journal of Thermal Spray Technology, 7, pp 205-212] was used to predict particle impact velocity.

$${V}_{p} = {V}_{e} \sqrt{\frac{{C}_{D} {A}_{p} {ρ}_{g} x}{{m}_{p}}} \qquad ( 1 )$$

where Vₚ is the particle impact velocity, Vₑ is the gas velocity at nozzle exit, C_{D} is the drag coefficient, Aₚ is the cross sectional area of the spray particles, x is the axial position as measured from the nozzle throat, mₚ is the mass of individual particles, and ρ_{g} is the gas density.

The drag coefficient was evaluated based on the suggested model expressed by Equation 2 by D. Helfritch and V. Champagne [Heifritch, D. and Champagne, V. 2008. A Model Study of Powder Particle Size Effects in Cold Spray Deposition, U.S. Army Research Laboratory.]

$${C}_{D} = \frac{24}{{R}_{e}} [ \frac{( 2 + 0.15 {R}_{e}^{0.687} ) ( 1 + {e}^{( - \frac{0.427}{{M}_{e}^{4.63}} + \frac{3}{{R}_{e}^{0.88}} )} )}{1 + [ ( \frac{{M}_{e}}{{R}_{e}} ) ( 3.82 + 1.28 {e}^{( - \frac{1.25 {R}_{e}}{{M}_{e}} )} ) ]} ] \qquad ( 2 )$$

where Rₑ is the Reynolds number based on the flow exit conditions and an average spray particle size, and Mₑ is the Mach number of the gas-particle velocity difference.

The particle impact model was based on research conducted by W. de Rosset [de Rosset, W. S. 2006. Modeling Impacts for Cold-Gas Dynamic Spray, Army Research Laboratory.]. The particle depth-of-penetration was calculated by way of Equation 3.

$$\frac{X}{{r}_{p}} = [ \frac{\frac{L {ρ}_{p}}{{d}_{p} {ρ}_{t}} + {K}_{1}}{2 {K}_{t}} ] ln ( 1 + \frac{{K}_{t} {ρ}_{t} {V}_{p}^{2}}{{R}_{t}} ) \qquad ( 3 )$$

where X/rₚ is the normalised penetration depth (X is the actual penetration depth by a particle of radius rₙ), L/dₚ=⅔ (assuming a sphere is the mass equivalent of a cylinder with L/dₚ=1), ρₚ is the powder density, ρₜ is the substrate density, K₁=0.557 and Kₜ=1.046 are fitting parameters suggested by de Rosset, and Rₜ is the substrate resistance as defined by Equation 4 below, where Yₜ is the substrate flow stress and Eₜ is the Young's Modulus of the substrate material.

$${R}_{t} = \frac{7}{3} [ {ln ( \frac{2 {E}_{t}}{3 {Y}_{t}} )}^{\frac{1}{3}} ] {Y}_{t} \qquad ( 4 )$$

Theoretical analysis proved a powerful first approximation tool. In the pursuit of reducing the current uncertainty involved with parameter selection in the cold spray process, this model offers an alternative approach to coating quality evaluation. By considering the particle depth-of-penetration as the key discriminating criterion the powder-substrate properties and interactions may be evaluated and used to make informed parameter selections.

3D Printed Substrate Design

3D printing allows for the possibility of retro-fitted and custom components, making this an ideal approach to substrate development. An uPrint SE 3D printer from Stratasys was used to print the ABS (Acrylonitrile, Butadiene and Styrene) substrates used in this example. Three interior fill styles are possible (i) solid (for high strength components), (ii) sparse high density (solid shell with an internal structural lattice), and (iii) sparse low density (solid shell with a honeycombed interior, for the quickest build times and lowest material consumption). A solid interior fill for high strength substrates was selected.

Part orientation during 3D printing influences, not only component build speed, but also its strength and surface finish. It is believed that the surface roughness may contribute to the successful coating of a polymeric material with a metal coating, improving coating cold spray deposition for coating development and influencing antimicrobial activity.

Cold Spray Coating

The bonding mechanism between impacting cold spray particles and the substrate may be broadly characterised by the interacting properties of the materials. The hardness ratio is seen to be an ideal parameter for this purpose. It is accepted that a soft-to-soft (soft spray particle impacting a soft substrate) or a hard-to-hard condition will, under carefully selected process parameters, result in acceptable particle penetration associated with a strong mechanical bond. A soft-to-hard condition observes negligible penetration and usually exhibits an insufficient bond for coating adhesion. In the current investigation a condition of hard cold spray particles impinging a soft polymer substrate, introduces concerns of deep particle embedment, coupled with potentially erosive depositions; justifying the development and use of a predictive theoretical cold spray model.

Based on the theoretical model's outputs and preliminary trial run testing a suitable parameter set for copper cold spray on 3D printed ABS substrates was achieved. It was expected that mechanical entanglement would represent the bonding mechanism for this powder-substrate combination. It is known that mechanical entanglement, which results in an interlocking of the spray particles and the substrate, is significantly affected by the operating gas temperature. Additionally, thermal effects were a concern considering the substrate material, which has a Vicat softening point of 108° C. Exposure to temperatures in excess of this causes thermal softening and may inhibit cold spray coating generation.

The theoretical model was therefore used to isolate a parameter set capable of achieving particle embedment, while minimising operating temperature. Refinement of the theoretical parameter set resulted in an ideal parameter set for coating generation for touch-contact applications.

The process was also repeated for other coating materials, including zinc, silver, blends of copper and/or zinc and/or silver, and a copper-aluminium-alumina blend. It is believed that these coatings constitute a group of suitable anti-microbial coatings for the purpose of this invention.

Based on the design methodology described above, the inventors arrived at the parameter ranges and set as set out in Table 1 below:

TABLE 1
Critical parameter ranges for cold spray
coating of 3D printed polymers

| Parameter | Broad Range | Preferable Range |
|---|---|---|
| Operating Pressure (MPa) | 0.6 < P < 1 | 0.75 < P < 0.85 |
| Operating Temperature (° C.) | 100 < T < 300 | 190 < T < 210 |
| Nozzle Standoff Distance (mm) | 5 < SOD < 30 | 5 < SOD < 15 |
| Nozzle Transverse Speed (mm/s) | 5 < NTS < 25 | 10 < NTS < 15 |
| Powder Feed Rate (%) | 20 < PFR < 50 | 25 < PFR < 35 |
| Step Distance (mm) | 2 < x < 6 | 4 < x < 6 |

Definitions of these parameters are provided below:
Operating pressure (P): The pressure, of the carrier gas during cold spraying, defined and set by the system operator.
Operating temperature (T): The temperature, to which the carrier gas is preheated, defined and set by the system operator.
Nozzle standoff distance (SOD): The perpendicular distance between the nozzle exit and the substrate surface, defined and set by the system operator.
Nozzle transverse speed (NTS or Vₙ): The lateral speed of the nozzle relative to the substrate surface, defined and set by the system operator.
Powder feed rate (PFR): The rate at which the feedstock powder enters the gas stream, defined and set by the system operator.
Step distance (x): The perpendicular offset distance between two parallel cold spray runs, defined and set by the system operator.

### Example 1—Basic Proof of Concept

A theoretical and experimental approach to cold spray on polymer substrates was made, preceding antimicrobial surface coating testing. Commercial, high purity copper powder from SST Centerline, Canada, was cold sprayed onto 3D printed ABS substrates. The cold spray process parameters were selected based on the outputs of a programmed theoretical cold spray model and preliminary trial run testing. Substrate design involved the selection of desirable 3D printer process parameters and 3D modelling design, including interior fill style, part orientation and surface geometry creation. Antimicrobial testing investigated the relative efficacy of copper cold sprayed surfaces against pure copper samples.

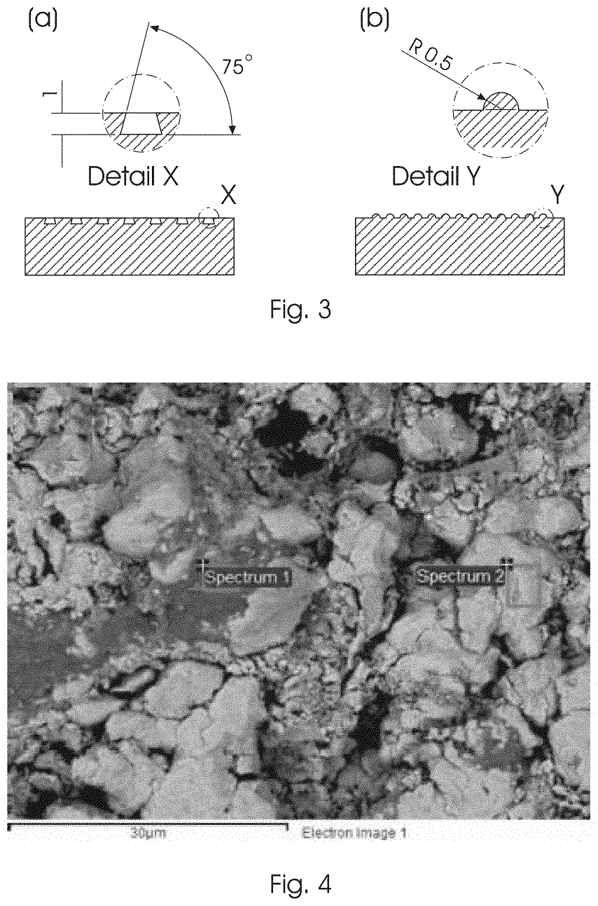

Specific surface geometries were designed based on the overarching requirements of improved cold spray deposition, coating adhesion, improved operational durability and enhanced antimicrobial ability. FIG. 3 depicts the two best performing surface geometries, besides the as-printed substrate surface finish. The as-printed surface finish refers to the topography of 3D printed surfaces due to printer specific properties, including: layer resolution, rate of deposition, layer paths and print environment conditions—including controlled air temperature.

The potential mitigation of infection transmission is dependent on the suitability and ultimate efficacy of the developed cold sprayed antimicrobial surfaces. The surface coating analysis and antimicrobial efficacy results are therefore also presented and discussed below.

Surface Coating Topography and Composition

Cold spray uniquely allows coating of thermally sensitive and chemically dissimilar materials, and direct fabrication and thick coatings are possible, making this an attractive additive manufacturing technique. 3D printing offers design-for-function opportunities; affording increased part complexity, tailored to a design's functional requirements. The integration of these two additive manufacturing techniques yielded positive results, with practical application potential.

Surface irregularity, coating thickness, porosity and composition of the developed coatings were evaluated. Cross-sectional images, obtained from an optical microscope, were used to obtain an average measure of surface irregularity. Surface irregularity is an indication of surface erosion and interfacial mixing by impacting spray particles on the 3D printed substrate. Coating topography effects were compared directly with a measured average surface irregularity of the unsprayed 3D printed surfaces. A second criterion was required in order to further evaluate coating quality. This criterion was coating profile; including coating thickness, porosity and composition. An average measure of coating thickness was obtained.

Based on the outputs from the theoretical model and the processed results, an ideal cold spray parameter set was isolated, one that achieved the best coating for an intended touch-contact application. This specific parameter set is given in Table 2.

TABLE 2
Experimental parameter set□

| | Exact Value for Copper |
|---|---|
| Parameter | Coating of 3D Printed ABS |
| Operating pressure (MPa) | 0.83 |
| Operating temperature (° C.) | 200 |
| Nozzle standoff distance (mm) | 20 |
| Nozzle transverse speed (mm/s) | 10 |
| Powder feed rate (%) | 20 |
| Spray gas | Air |
| Diverging length (mm) | 120 |
| Throat diameter (mm) | 2.5 |
| Exit diameter (mm) | 6.5 |
| powder | C5003 |
| Average particle size (μm) | 25 |
| Substrate temperature | 15 |
| Step distance (mm) | 4 |
| Ambient pressure (KPa) | 83 |
| Ambient temperature | 15 |

The relatively high operating temperature, at 200° C., was observed to produce a more uniform coating deposition than at lower temperatures. This resulted in a more efficient and evenly distributed layer deposition.

Substrate surface roughness has been shown, in specific cases, to achieve higher deposition efficiencies, especially of the first coating layer. This observed effect of roughness is a consequence of the increased surface area, improving deposition efficiency. The degree of roughness, induced by the as-printed substrates, played a critical role in cold spray surface quality; while the designed surface geometries led, in a number of cases, to increased surface erosion. This was related to the dissimilarity of the feedstock spray powder and substrate properties, as well as the designed surface features. It is known that deposition efficiency reduction is negligible if the spray axis is varied by less than 10° from the perpendicular. The substrates failed to withstand impact of cold spray particles in regions of unsupported or fine surface geometry, especially where the impingement angle deviated by more than 10° from perpendicular. Successful surface geometries exhibited suitable surface coating and were suspected to improve wear resistance.

Optical analysis of the test samples was conducted as the primary source of coating evaluation. Various visual inspections were made, including stereoscopic, optical and Scanning Electron Microscopy (SEM). A stereoscopic microscope (NIS-Elements on Nikon DS-U3) was used to obtain images of the cold spray run surfaces at higher magnifications. An optical microscope (Leica DM6000M with Leica DFC490 camera mount) was used to obtain high resolution images of the surface coating top and cross-sectional views respectively. SEM analysis, using a Zeiss Sigma SEM-EDX (Energy Diffraction X-ray) system, investigated coating morphology and composition.

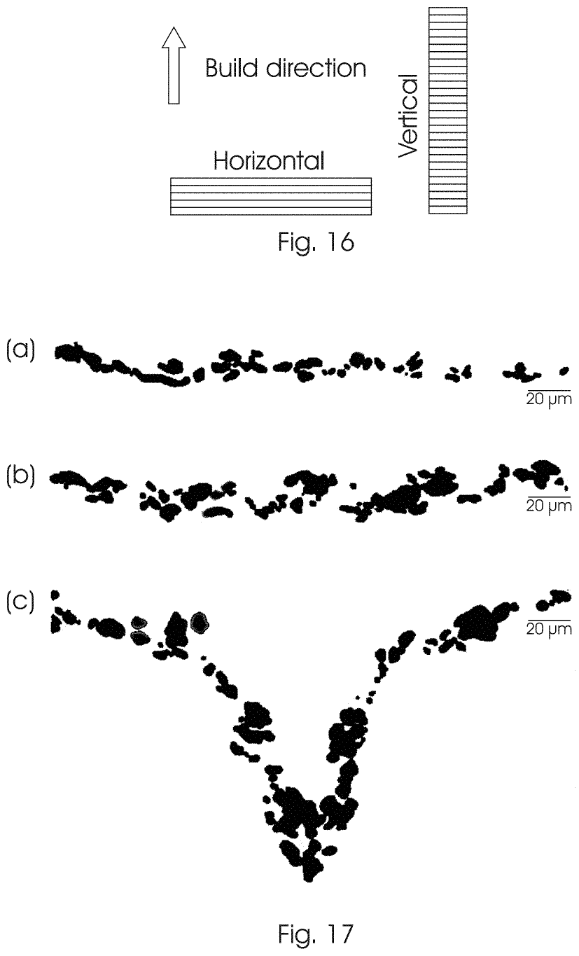

Cross sectional micrographs, isolating the coating material, were used to evaluate coating profiles from three unique substrates. FIG. 16 illustrates the vertical and horizontal 3D print orientations referred to in this specification. FIG. 17 depicts binary micrographs of three coating types, namely: a copper coating on (a) solid ABS, (b) horizontally oriented 3D printed ABS and on (c) vertically oriented 3D printed ABS. The valley in FIG. 17(c) is typical of the 3D printer layering when printing in the vertical orientation and is evidence for minimal substrate distortion during cold spraying.

With reference to FIG. 17 the substrate for coating (a) had an average arithmetic mean surface roughness (Ra) of 0.4 μm, while for coatings (b) and (c) Ra values of 4.3 μm and 7.4 μm were observed respectively. An increased substrate roughness set the conditions for a thicker coating build up (70% thicker for the case of a vertically oriented 3D printed ABS substrate when compared to that of a solid ABS substrate), increased percent metallisation and even resulted in the deposition of larger particles for both the first layer and subsequent coating layers. Table 3 contains the trends observed as a consequence of increased substrate roughness.

TABLE 3
Coating profile trends based on the effects of substrate surface
roughness for copper cold spray coatings on polymer substrates.

| Substrate surface | Average particle | Average particle | Coating | Average coating | Percentage |
|---|---|---|---|---|---|
| roughness | size in first | size in coating | roughness | thickness | metallisation |
| (Ra) [μm] | layer [μm] | layers [μm] | (Ra) [μm] | [μm] | [%] |
| SD = 0.4 | SD = 4.5 | SD = 0.8 | SD = 0.5 | SD = 6.0 | SD = 7 |
| 0.4 | 9.2 | 7.1 | 1 | 11.4 | 22 |
| 4.3 | 9.3 | 8.8 | 3.6 | 14.6 | 29 |
| 7.4 | 12.1 | 10.4 | 6.1 | 19.4 | 36 |

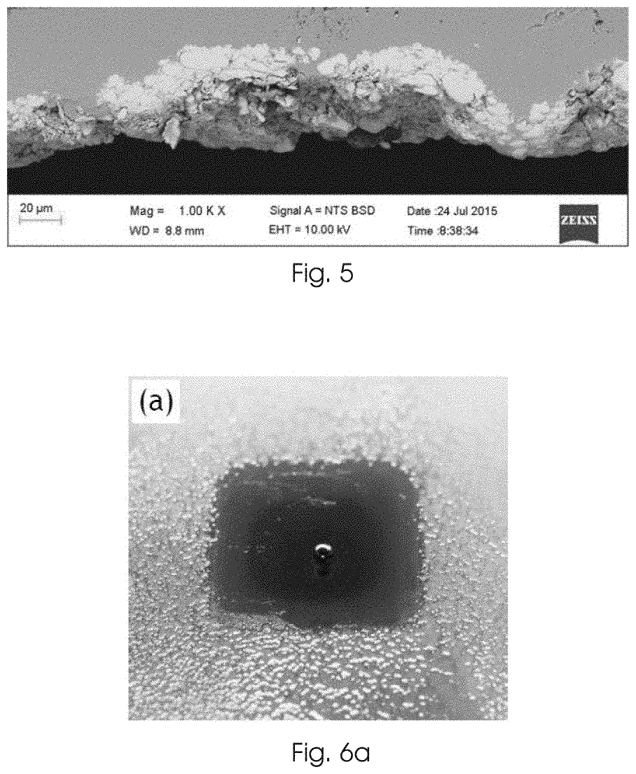

Evaluation of the resultant surface morphology, particle depth-of-penetration and overall coating quality of the as-printed, as-sprayed surface coatings was made accordingly. EDX analysis identified the elemental composition of these coatings, as depicted in FIG. 4. Spectrum 2 contained approximately 82% copper content (by weight), while only 4.7% in Spectrum 1. This alone suggested a heterogeneous mixed coating. A threshold segmentation analysis, using image processing software, ImageJ, indicated an overall copper coverage of approximately 73%. The results are suggestive of material jetting, inducing effective mechanical entanglement. The copper coating, although thin, as seen in FIG. 5, proved sufficient in the antimicrobial testing.

The surface topography is suggestive of a suitable surface for antimicrobial applications. The unique surface features inherent to the as-printed 3D printed surface finish, designed surface geometries and the effects of the cold spray process, were expected to perform well in subsequent antimicrobial testing.

Antimicrobial Efficacy

Antimicrobial testing involves: a contamination process, at which point a solution, sample or medium is inoculated with the test micro-organism and the antimicrobial test samples are suitably brought into contact; an incubation period, during which time the micro-organisms attempt to colonise while the test samples, in theory, resist or actively eliminate them; lastly an efficacy analysis is made, either qualitatively or quantitatively.

Two independent diffusion test procedures were carried out. The general procedural setup involved inoculating an agar plate and either embedding the test samples, active-coating-side up, just beneath the surface (see Antimicrobial test case 1), or placing the test samples active-coating-side down, on top of the agar surface (see Antimicrobial test case 2). An incubation period followed, after which the relative efficacy was evaluated based on the effective size of the zones of inhibition around the test samples.

Antimicrobial Test Case 1

A 1×10⁶ Colony Forming Units (CFU)/ml concentration of Staphylococcus aureus (ATCC 25923), Pseudomonas aeruginosa (ATCC 27858) and Candida albicans (ATCC 10231) inoculated three agar trays respectively. Test samples were sterilized with ethanol and allowed to dry. Following sterilization, the test carriers (copper cold sprayed coatings on 3D printed ABS substrates with various surface geometries) and control samples (pure copper, stainless steel, mild steel, 3D printed ABS and a positive control disc (PCD) in the form of a Neomycin 10 μg disc for the Gram-positive and Gram-negative test organisms and a Nystatin oxoid 100 μg disc for the yeast) were embedded just below the surface of the inoculated agar trays. S. aureus and P. aeruginosa trays were then incubated at 37° C. for 24 hours, while the C. albicans tray was incubated for 48 hours.

Antimicrobial Test Case 2

The second test case evaluated antimicrobial ability of the developed surface coatings against contaminated water supplies. The contaminated water was supplied by Eskom's Research and Innovation Centre, in the form of cooling tower water—a high concentration blend of water, organics and bacteria. A pre-growth test procedure, evaluating biocidal activity, involved inoculating an agar solution with the cooling tower water, which was then plated and incubated at 35° C. for 48 hours. Following this, sterilized test samples and controls were placed face down on these incubated plates. A second batch was prepared that did not undergo the initial incubation. This was used for a simultaneous incubation test, evaluating microbial inhibitory action from test samples. Plates were then incubated at 35° C. for 48 hours.

For both test cases an antimicrobial efficacy assay was made from the results. The zone of inhibition was used as the key discriminating criterion.

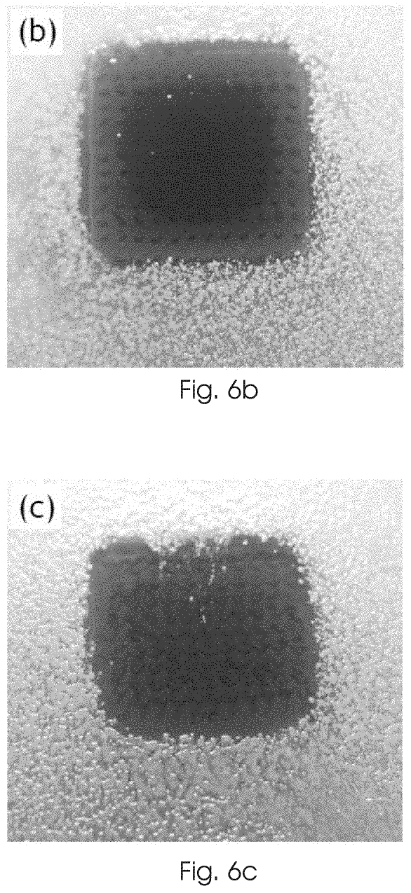

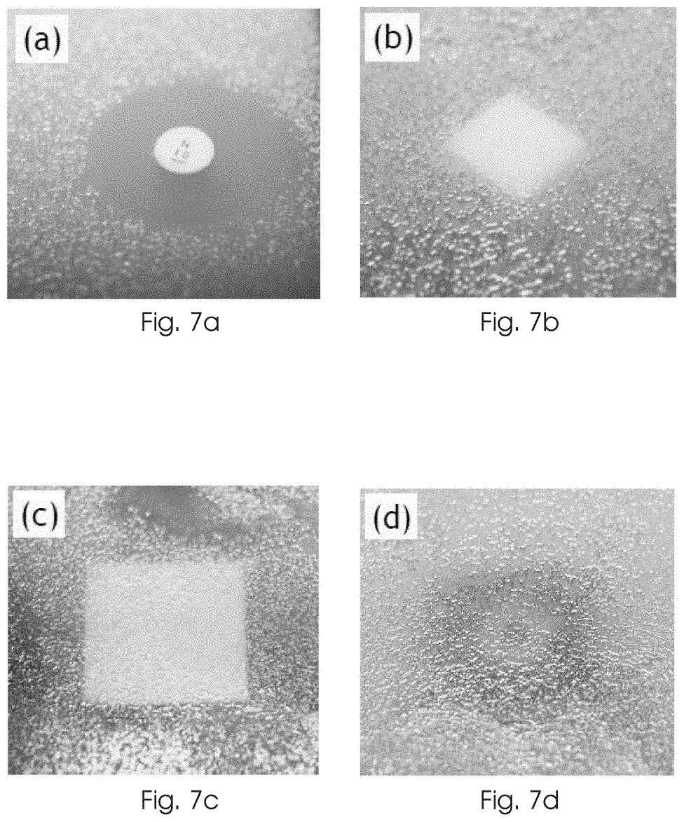

Antimicrobial efficacy was observed for both test cases. Results from antimicrobial test case 1 included the effects of surface topography and are presented here. FIG. 6 depicts the zones of inhibition for various test samples after exposure of S. aureus. A rapid transition boundary between S. aureus colonies (speckled white region) and the zone of inhibition (clear region) reached at the test sample edges of all three test samples, is indicative of inhibition advantage gained from developed coatings under diffusive antimicrobial testing. Compared to the various control samples, as depicted in FIG. 7, the developed surface coatings proved effective antimicrobial agents, outperforming even pure copper samples. The Neomycin PCD—FIG. 7(a)—represents a strong positive response, validating any antimicrobial activity observed by the designed test samples. Similar results were obtained for P. aeruginosa and C. albicans.

The results for the second set of antimicrobial tests, investigating antimicrobial efficacy of copper cold spray coatings against contaminated water, corroborated the findings of the first test case. While biocidal activity was not explicitly observed, definite inhibitory activity was confirmed. In addition, the cold sprayed test samples outperformed the pure copper samples; exhibiting enhanced antimicrobial ability. Surface characteristics of increased surface area and cold spray effects were suggested as a probable cause.

The aforementioned antimicrobial tests took the form of semi-liquid testing. An antimicrobial study previously conducted on metallic copper suggested that dry copper surfaces are more antimicrobially effective than wet contact surfaces. The potential application of the developed material is ultimately for dry contact surface protection, and therefore the positive results obtained in an essentially wet contact environment only strengthens the potential for these surfaces within the healthcare environment for touch-contact applications.

The results suggest that the copper cold spray coatings are inhibitors to microbial growth and therefore effective antimicrobial agents. It was further postulated that surface area enhancement attributed to an improved efficacy, as seen by the heightened antimicrobial ability of the cold spray coatings (FIG. 6) compared with that of pure copper (FIG. 7d). There was, however, no discernible difference between samples with designed surface geometries and those without. Suggesting that as-printed substrates offer suitable topographical effects to aid cold spray deposition and enhance antimicrobial ability.

### Example 2—Verification of Further Combinations, Antimicrobial Susceptibility Testing, and Prototype Testing

Cold Spray Process Parameters

The parameter set ranges and optimised, precise values for 11 unique material combinations were defined. Optimised cold spray parameter selection made use of theoretical model predictions, optimisation strategies and experimental approaches. Cold spray feedstock powders included standard powder types—99.7% copper (C5003 Centerline), 99.7% zinc (Z5001 Centerline) and a 99.7% copper, 99.5% aluminium and 92% alumina blend (C0075 Centerline)—as well as various unique powder blends, including a 5 wt % silver additive (99.99% Ag Sigma-Aldrich) and copper-zinc blends. Two build orientations (horizontal and vertical) for the acrylonitrile butadiene styrene (ABS) 3D printed substrates were tested. The print orientation has a direct influence on the surface topography, which offers additional design versatility for various applications, particularly for touch-contact surfaces. The two extremes, namely horizontal and vertical, were used as test cases for substrate surface design.

The experimentally optimum cold spray parameter sets are given in Table 4. This table (Table 4) also provides a detailed naming convention for the developed cold spray coated materials. Materials in this report may by referred to either by the specific coating and substrate combination, or by a reference number unique to each material. Copper (Cu), zinc (Zn) and silver (Ag) are the three main antimicrobially active metal powders used in these examples, together with a copper-aluminium-alumina powder blend (Aluminium—Al).

TABLE 4
Optimum cold spray parameter set values for polymer metallisation of 3D printed substrates

| | | | | | Nozzle | Nozzle | | |
|---|---|---|---|---|---|---|---|---|
| | | 3D Printed ABS | Operating | Operating | Standoff | Transverse | Powder | Step |
| | Coating | Substrate | Pressure | Temperature | Distance | Speed | Feed Rate | Distance |
| Ref No. | Material | Orientation | (MPa) | (° C.) | (mm) | (mm/s) | (%) | (mm) |
| 1 | Copper | Horizontal | 0.75 (109 Psi) | 190 | 5 | 15 | 30 | 4 |
| 2 | Copper | Vertical | 0.75 (109 Psi) | 190 | 5 | 15 | 30 | 4 |
| 3 | Copper-aluminium- | Horizontal | 0.75 (109 Psi) | 190 | 15 | 15 | 30 | 4 |
| | alumina | | | | | | | |
| 4 | Zinc | Horizontal | 0.8 (116 Psi) | 200 | 10 | 15 | 30 | 5 |
| 5 | 75 wt % copper-25 wt | Horizontal | 0.85 (123 Psi) | 210 | 15 | 12 | 30 | 6 |
| | % zinc | | | | | | | |
| 6 | 50% (w/w) copper-zinc | Horizontal | 0.85 (123 Psi) | 200 | 15 | 10 | 30 | 6 |
| 7 | 75 wt % zinc-25 wt % | Horizontal | 0.7 (102 Psi) | 180 | 15 | 10 | 30 | 6 |
| | copper | | | | | | | |
| 8 | 5 wt % silver-95 wt % | Vertical | 0.75 (109 Psi) | 190 | 5 | 15 | 30 | 4 |
| | copper | | | | | | | |
| 9 | 5 wt % silver-95 wt % | Horizontal | 0.75 (109 Psi) | 190 | 5 | 15 | 30 | 4 |
| | copper | | | | | | | |
| 10 | 5 wt % silver-47.5% | Horizontal | 0.85 (123 Psi) | 200 | 15 | 10 | 30 | 6 |
| | (w/w) copper-zinc | | | | | | | |
| 11 | 5 wt % silver-95 wt % | Horizontal | 0.8 (116 Psi) | 200 | 10 | 15 | 30 | 5 |
| | zinc | | | | | | | |

A cold spray parameter set is specifically tailored to a given coating-substrate combination and therefore one parameter set cannot simply be transferred to other combinations. In this way the Arnold disclosure, which covers a broad range of parameter values does not enable the development of unique coating types as contained in Table 4.

By way of example, comparing a silver additive copper coating (sample 9) to that of a silver additive zinc coating (sample 11), on the same 3D printed ABS substrate, the copper dominant coating requires twice the nozzle standoff distance and around a 6% percent reduction in operating pressure, of that of the zinc dominant coating. This specialization of process parameters is even more pronounced for the 50% (w/w) copper-zinc blended coating (sample 6); which requires a 13% increase in operating pressure, over 5% increase in operating temperature, a 200% increase in nozzle standoff distance, a 33% reduction in nozzle transverse velocity and a 50% increase in the step distance, when compared to the process parameters for a pure copper coating (sample 1).

Antimicrobial Susceptibility Testing

Antimicrobial susceptibility testing (AST) in the form of a diffusion assay and a dry contact time kill analysis was conducted on all developed materials, incorporating all relevant control samples. The methodology and results are summarised below.

Diffusion Assay:

A diffusion assay, which evaluates antimicrobial activity based on the extent of inhibition surrounding an antimicrobial agent, when in contact with a culture-seeded agar plate, was conducted. The size of the zone of inhibition is proportional to the efficacy of the antimicrobial agent against that pathogen. The details of the diffusion test cultures, controls and materials are summarised below

Diffusion Assay Setup:
Pathogens
   Staphylococcus aureus (ATCC 25923)
   Enterococcus faecalis (ATCC 29212)
   Klebsiella pneumoniae (ATCC 13887)
   Pseudomonas aeruginosa (ATCC 27853)
   Candida albicans (ATCC 10231)
Resistant and Multi-Resistant Pathogens
   Gentamicin-methicillin-resistant S. aureus (GMRSA) (ATCC 33592)
   Reference P. aeruginosa (DSM 46316)
   Clinically resistant C. albicans (#4122)
Antimicrobial Controls
   Ciprofloxacin (5 μg—disc)
   Nystatin (100 μg—disc)
   Amphotericin B (0.1 mg/ml—solution)
Coatings
   Copper, copper-aluminium-alumina, zinc and various powder blends with the inclusion of 5 wt % silver
Substrates
   3D printed ABS (two orientations—horizontal and vertical)

Diffusion Assay Procedure:

The diffusion test procedure used was based on the procedure described in the Manual of Antimicrobial Susceptibility Testing, S. J. Cavalieri, et al. 2005 American Society for Microbiology-Disk Diffusion Testing, and is detailed below. The aim of this test is to evaluate the diffusive activity of test specimens, by measuring the extent of a zone of inhibition, indicative of growth restriction and/or biocidal activity from the test sample. The larger the zone of inhibition the greater the diffusive efficacy.

1. Prepare agar plates.
1.1. Prepare Tryptone Soya agar (TSA) solution.
   1.1.1. Sterilise all working surfaces.
   1.1.2. Suspend 40 g of TSA (CM0131) in 1 litre of purified water.
   1.1.3. Shake until dissolved.
   1.1.4. Autoclave at 121° C. for 15 minutes.
1.2. Pour agar plates.
   1.2.1. Aseptically pour a fixed volume of autoclaved TSA solution into the test plates (petri dishes or trays).
   1.2.2. Allow agar to set before use.

2. Prepare culture inoculate.
2.1. Prepare a 0.5 McFarland's culture dilution in Tryptone Soya broth (TSB).
2.2. Streak cultures to confirm culture purity, strain and concentration.

3. Sterilise test samples.
3.1. Dip samples in a 70% alcohol solution.
3.2. Dry samples in an aseptic environment, preferably within a laminar flow unit.

4. Spread Inoculate.
4.1. Micro-pipette an aliquot (100 μl of 10⁶ CFU/ml) of inoculate onto a prepared agar plate.
4.2. Spread evenly across agar with an L-shaped, sterile spreader.

5. Place test specimens.
5.1. Map out sample placement, ensuring sufficient spacing between samples to prevent overlapping zones of inhibition.
5.2. Place specimens with sterile forceps coating side down onto the prepared agar plates.
5.3. Press down on samples to ensure uniform contact with inoculated agar surface.

6. Incubate plates.
6.1. Refrigerate plates for one hour.
6.2. Transfer plates to incubator and incubate for 16-24 hours at 37° C. for bacterial inoculates and 48 hours at 37° C. for fungal inoculates.

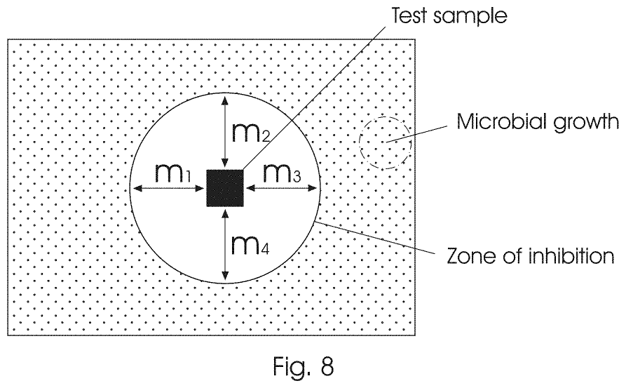

7. Measure and record zones of inhibition.
7.1. Remove plates from incubator.
7.2. Place under suitable lighting conditions (use of a light box may be required).
7.3. Measure the extent of the zones of inhibition (to the nearest 0.1 mm), as demonstrated in FIG. 8. A zone of inhibition measurement is taken from the sample/disc edge to the extent of inhibition. The average of four readings (m₁, m₂, m₃, m₄) represents the recorded zone of inhibition.

Diffusion Assay Results:

The raw cold spray feedstock powders were tested under these diffusive conditions and the following results were obtained, as depicted in Table 5. It was interesting to observe a lack of activity from the silver powder, when this metal is known to be especially antimicrobially active. The coatings with a 5 wt % silver additive, however, showed promising antimicrobial activity.

TABLE 5
Diffusion assay zones of inhibition for cold spray feedstock powders

| | Average Zone of Inhibition | | | | |
|---|---|---|---|---|---|
| | (measured from powder sample edge to the inhibition edge) [mm] | | | | |
| | S. aureus | E. faecalis | K. pneumoniae | P. aeruginosa | C. albicans |
| Test Sample | ATCC 25923 | ATCC 29212 | ATCC 13887 | ATCC 27853 | ATCC 10231 |
| 99.7% copper (C5003 Centerline) | 4.7 | 4.1 | 2.9 | 4.4 | 0.8 |
| 99.7% copper, 99.5% aluminium and | 4.0 | 3.1 | 2.8 | 4.6 | 0.0 |
| 92% alumina blend (C0075 Centerline) | | | | | |
| 99.7% zinc (Z5001 Centerline) | 3.0 | 1.4 | 0.8 | 3.0 | 0.0 |
| 75 wt % copper - 25 wt % zinc | 1.8 | 2.0 | 4.4 | 6.9 | 1.6 |
| 50% w/w copper-zinc | 1.4 | 0.9 | 3.6 | 6.1 | 0.5 |
| 75 wt % zinc - 25 wt % copper | 3.6 | 0.6 | 4.0 | 6.0 | 0.5 |
| 99.99% silver (Sigma-Aldrich) | 0.0 | 0.3 | 0.8 | 3.1 | 0.0 |
| Ciprofloxacin/Nystatin Control | 10.6 | 10.6 | 18.7 | 14.3 | 5.6 |

Three stages to the disc diffusion testing of the developed coatings were followed.
1. All developed coatings were tested for diffusive antimicrobial activity against the five pathogens: S. aureus, E. faecalis, P. aeruginosa, K. pneumoniae and C. albicans.
2. Silver containing coatings were tested against these same pathogens.
3. The best performing coatings were tested against three resistant microbial strains: Gentamicin-methicillin-resistant S. aureus (GMRSA) ATCC 33592, reference P. aeruginosa DSM 46316 and clinically resistant C. albicans.

The following summarises the findings from the diffusion testing.

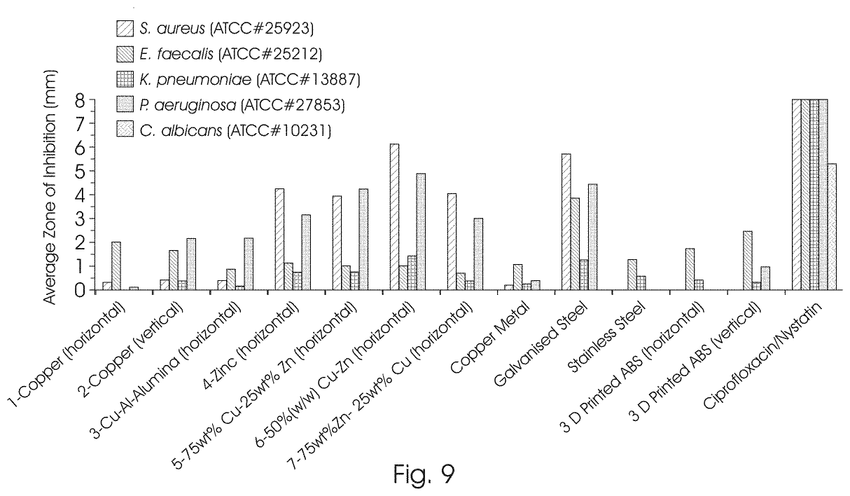

FIG. 9 depicts the average zone of inhibition sizes for various copper and zinc coated samples. It is noted that the coating material and 3D printed ABS substrate orientation are used to identify each material i.e. ‘Copper (horizontal)’ is a cold spray copper coating on a horizontally oriented 3D printed ABS substrate.

A 50:50 copper-zinc blended coating on 3D printed ABS (horizontal) substrates was seen to exhibit synergistic activity. This was particularly evident against S. aureus, P. aeruginosa and K. pneumoniae. Synergy or synergistic behaviour is defined as the interaction of two or more agents to produce a combined effect greater than the sum of their separate effects. Synergistic activity is therefore confirmed for a 50% (w/w) copper-zinc coating on a 3D printed ABS (horizontal) substrate, when comparing this coating's average zone of inhibition to that of the combined average of separate copper and zinc coatings on the same substrate material. This material does, however, appear to exhibit a marginal reduction in antimicrobial activity when in contact with E. faecalis, compared to each independent coating. This activity, however, is seen to be the same as that afforded by pure copper, which is a known and effective antimicrobial agent. The cold spray coatings did not, however, show antimicrobial activity against C. albicans, a pathogenic yeast.

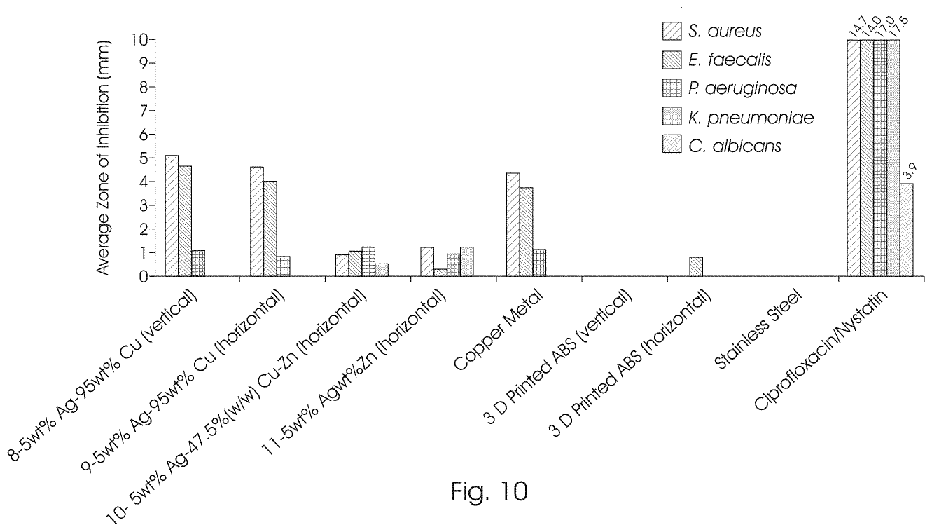

Silver additives were blended with the best performing coatings' feedstock powders. FIG. 10 depicts the diffusion results for the silver containing samples.

S. aureus and E. faecalis are classified as Gram-positive bacteria, P. aeruginosa and K. pneumoniae are classified as Gram-negative bacteria and C. albicans is a yeast. A direct comparison was made between the original coatings and the coatings with a 5 wt % silver additive. The results are depicted in table 6 (6.1, 6.2, 6.3) below. Neither the original coatings nor the silver additive samples showed any antimicrobial activity against C. albicans in a diffusive test environment and are therefore left out of this comparison.

TABLE 6.1
Comparison between original and silver additive coatings based
on an average zone of inhibition from all test pathogens.

| | Average ZOI | Best |
|---|---|---|
| Test Sample | [mm] | Performing |
| 2 - Copper on 3D printed ABS (vertical) | 0.9 | 8 |
| 8 - 5 wt % silver - 95 wt % copper on 3D | 2.2 | |
| printed ABS (vertical) | | |
| 1 - Copper on 3D printed ABS (horizontal) | 0.5 | 9 |
| 9 - 5 wt % silver - 95 wt % copper on 3D | 1.9 | |
| printed ABS (horizontal) | | |
| 6 - 50% (w/w) Cu—Zn on 3D printed ABS | 2.7 | 6 |
| (horizontal) | | |
| 10 - 5 wt % Ag - 47.5% (w/w) Cu—Zn | 0.7 | |
| on 3D printed ABS (horizontal) | | |
| 4 - Zinc on 3D printed ABS (horizontal) | 1.9 | 4 |
| 11 - 5 wt % Ag - 95 wt % Zn on 3D printed | 0.7 | |
| ABS (horizontal) | | |

TABLE 6.2
Comparison between original coatings and silver additives based on
an average zone of inhibition from Gram-positive test pathogens.

| | Average ZOI | Best |
|---|---|---|
| Test Sample | [mm] | Performing |
| 2 - Copper on 3D printed ABS (vertical) | 1.1 | 8 |
| 8 - 5 wt % silver - 95 wt % copper on 3D | 4.9 | |
| printed ABS (vertical) | | |
| 1 - Copper on 3D printed ABS (horizontal) | 1.2 | 9 |
| 9 - 5 wt % silver - 95 wt % copper on 3D | 4.3 | |
| printed ABS (horizontal) | | |
| 6 - 50% (w/w) Cu—Zn on 3D printed ABS | 3.6 | 6 |
| (horizontal) | | |
| 10 - 5 wt % Ag - 47.5% (w/w) Cu—Zn | 1.0 | |
| on 3D printed ABS (horizontal) | | |
| 4 - Zinc on 3D printed ABS (horizontal) | 2.7 | 4 |
| 11 - 5 wt % Ag - 95 wt % Zn on 3D printed | 0.8 | |
| ABS (horizontal) | | |

TABLE 6.3
Comparison between original coatings and silver additives based on
an average zone of inhibition from Gram-negative test pathogens.

| | Average ZOI | Best |
|---|---|---|
| Test Sample | [mm] | Performing |
| 2 - Copper on 3D printed ABS (vertical) | 1.3 | 2 |
| 8 - 5 wt % silver - 95 wt % copper on 3D | 0.6 | |
| printed ABS (vertical) | | |
| 1 - Copper on 3D printed ABS (horizontal) | 0.1 | 9 |
| 9 - 5 wt % silver - 95 wt % copper on 3D | 0.5 | |
| printed ABS (horizontal) | | |
| 6 - 50% (w/w) Cu—Zn on 3D printed ABS | 3.1 | 6 |
| (horizontal) | | |
| 10 - 5 wt % Ag - 47.5% (w/w) Cu—Zn | 0.9 | |
| on 3D printed ABS (horizontal) | | |
| 4 - Zinc on 3D printed ABS (horizontal) | 2.0 | 4 |
| 11 - 5 wt % Ag - 95 wt % Zn on 3D printed | 1.1 | |
| ABS (horizontal) | | |

The addition of silver to the various copper coatings had a positive effect on antimicrobial activity against Gram-positive pathogens, but not against Gram-negative bacteria, except in the case of a silver and copper blended coating on 3D printed ABS (horizontal orientation). Silver, as an additive to zinc coatings, did not result in any improved antimicrobial activity, regardless of the pathogen for the diffusion tests.

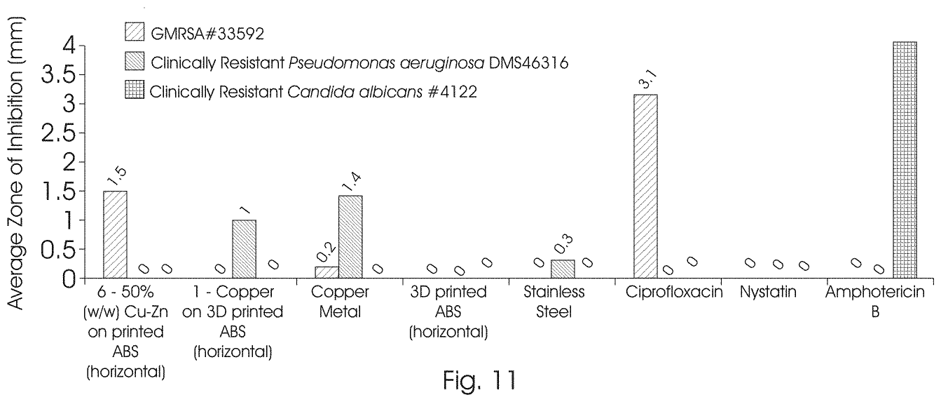

The two best performing materials were tested against the resistant microbial strains (Gentamicin-methicillin-resistant S. aureus (GMRSA), resistant reference P. aeruginosa and clinically resistant C. albicans). The diffusion test results for these samples are depicted in FIG. 11. Again the materials had no antimicrobial affect against the fungal pathogen, clinically resistant C. albicans; but the blended coating was active against the Gram-positive pathogen and the copper coating showed antimicrobial activity against the Gram-negative pathogen.

Dry, Touch-Contact Tests (Adapted Time Kill Assay)

A dry, touch-contact, time kill test procedure, based on the test procedures described in Inactivation of Bacterial and Viral Biothreat Agents on Metallic Copper Surfaces, Bleichert et al, Biomaterials, 27: 1179-1189, Contribution of Copper Ion Resistance to Survival of Escherichia coli on Metallic Surfaces, Applied and Environmental Microbiology, Santo et al, 74(4): 977-986 and the US Environmental Protection Agency's Protocol for the Evaluation of Bactericidal Activity of Hard, Non-porous Copper Containing Surface Products, was designed and conducted; which aimed to simulate dry touch-contact activity from the developed coatings. A culture suspension (5 μl inoculate at a concentration of approx. 10⁶-10⁸ CFU/ml) was spread onto 12×12 mm samples; which were incubated at room temperature, then neutralised in a saline solution after a pre-determine contact period (0.5, 5, 10, 15, 20, 60 and 180 minutes). Serial dilutions, agar plating, incubation and viable colony counts followed and the procedure repeated for all samples at all time periods.

Dry Contact Test Setup:
Pathogens
   Staphylococcus aureus (ATCC 25923)
   Pseudomonas aeruginosa (ATCC 27853)
   Candida albicans (ATCC 10231)
Resistant and multi-resistant pathogens
   Gentamicin-methicillin-resistant S. aureus (GMRSA) (ATCC 33592)
   Reference P. aeruginosa (DSM 46316)
   Clinically resistant C. albicans (#4122)
Coatings
   Copper, copper-aluminium-alumina, zinc and various blends with
   the inclusion of 5 wt % silver
Substrates
   3D printed ABS (two orientations—horizontal and vertical)

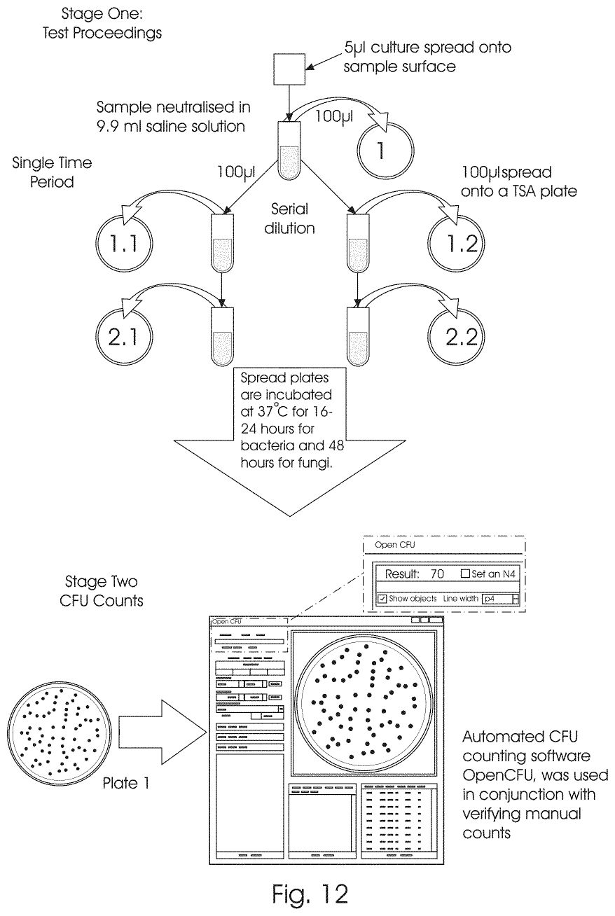

FIG. 12 depicts an annotated graphical representation of the test method employed.

Dry Contact Test Results:
1) Original coatings on 3D printed ABS substrates (excluding silver) and standard pathogens (S. aureus, P. aeruginosa and C. albicans).
2) Silver additive coatings and standard pathogens.
3) Resistant microbial strains—best performing materials.

### 1) Original Coatings on 3D Printed ABS Substrates (Vertical and Horizontal Orientations)

The following tables summarise the results from the dry contact time kill assay for all original coatings against the three pathogens: S. aureus, P. aeruginosa and C. albicans.

Table 7 summarises the dry contact results for S. aureus. The samples are ranked from highest antimicrobial activity. The best performing polymer based material is detailed further here. The key criteria are the highest percentage reduction in viable micro-organisms and, as a consistent point of comparison, the percentage reduction after a 15 minute exposure period.

TABLE 7
Summary of dry contact test results for
original coatings against S. aureus

| | Pathogen: S aureus (ATCC 25923) | | |
|---|---|---|---|
| Rank | Sample No. | Highest Percent Reduction | minutes |
| 1 | 2 - Copper (vertical) | 100% @ 15 min | 100% |
| 2 | 1 - Copper (horizontal) | 100% @ 20 min | 99.99% |
| 3 | 3 - Cu—Al-Alumina | 100% @ 3 hours | 99.78% |
| | (horizontal) | | |
| 4 | 6 - 50% (w/w) | 99.92% @ 3 hours | 99.58% |
| | Cu—Zn (horizontal) | | |
| 5 | 5 - 75 wt % Cu - 25 | 99.80% @ 3 hours | 98.97% |
| | wt % Zn (horizontal) | | |
| 6 | 7 - 75 wt % Zn - | 99.06% @ 3 hours | 98.42% |
| | 25 wt % Cu | | |
| | (horizontal) | | |
| 7 | 4 - Zinc (horizontal) | 99.25% @ 1 hour | 97.46% |
| 8 | Galvanised steel | 97.44% @ 20 min | 91.76% |
| 9 | Copper metal | 98.52% @ 3 hours | 91.60% |
| 10 | Stainless steel | 85.67% @ 5 min | 77.99% |

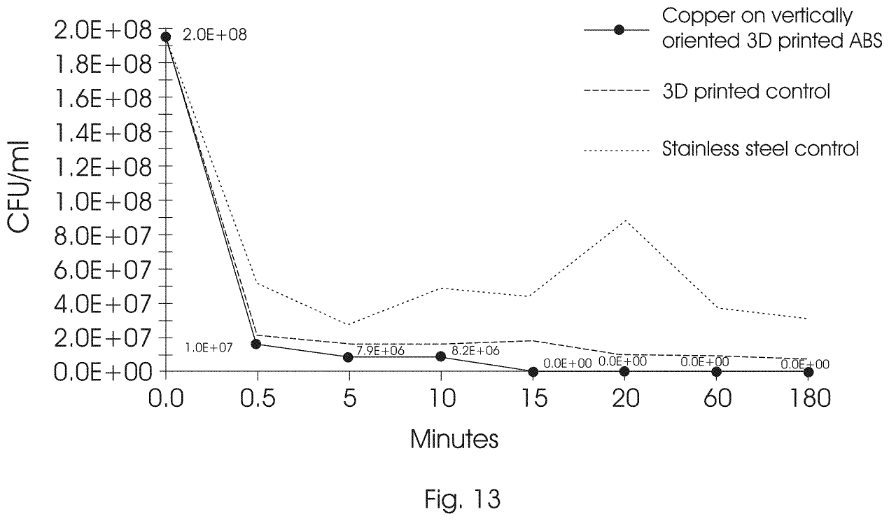

The best performing polymer based material against S. aureus is seen to be a cold spray copper coating on a vertically oriented 3D printed ABS substrate (Sample No. 2). FIG. 13 depicts the time kill graph for this material, recording the average CFU/ml present at each respective time period. This material observed complete bacterial elimination within a 15 minute exposure period compared to a 98.5% reduction in viable CFUs after three hours for copper metal, a known antimicrobial agent.

Table 8 summarises the dry contact results for P. aeruginosa.

TABLE 8
summary of dry contact test results for original
coatings against P. aeruginosa

| | Pathogen: P aeruginosa (ATCC 27853) | | |
|---|---|---|---|
| Rank | Sample No. | Highest Percent Reduction | minutes |
| 1 | 1 - Copper (horizontal) | 100% @ 10 min | 100% |
| 2 | 2 - Copper (vertical) | 100% @ 15 min | 100% |
| 3 | 7 - 75 wt % Zn - | 100% @ 20 min | 98.67% |
| | 25 wt % Cu | | |
| | (horizontal) | | |
| 4 | 3 - Cu—Al-Alumina | 100% @ 10 min | 100% |
| | (horizontal) | | |
| 5 | Galvanised steel | 100% @ 3 hours | 93.59% |
| 6 | 6 - 50% (w/w) | 100% @ 3 hours | 99.95% |
| | Cu—Zn | | |
| | (horizontal) | | |
| 7 | 5 - 75 wt % Cu - | 99.99% @ 3 hours | 99.32% |
| | 25 wt % Zn | | |
| | (horizontal) | | |
| 8 | Copper metal | 99.97% @ 3 hours | 73.44% |
| 9 | 4 - Zinc (horizontal) | 99.95% @ 3 hours | 98.19% |
| 10 | Stainless steel | 98.59% @ 3 hours | 37.54% |

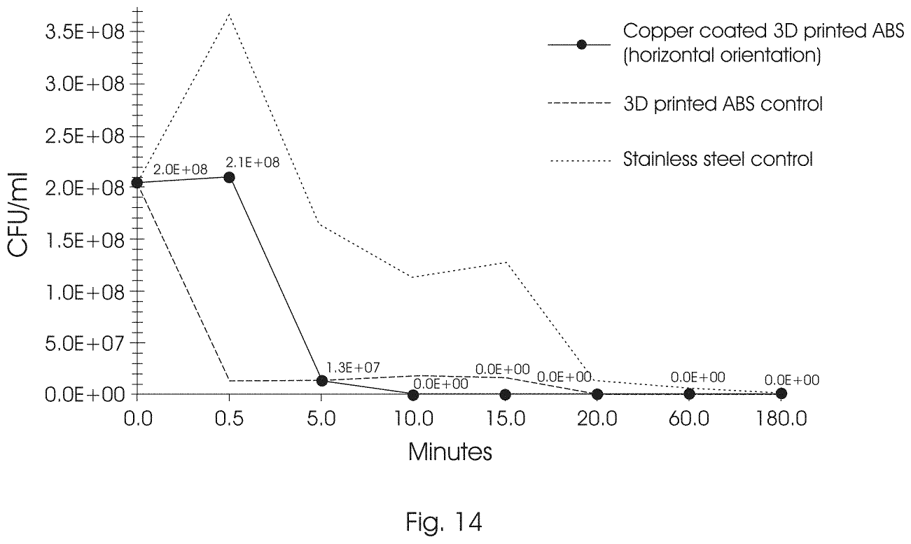

The best performing polymer based material against P. aeruginosa is seen to be a cold spray copper coating on an 3D printed ABS substrate (horizontal orientation) (Sample No. 1). FIG. 14 depicts the time kill graph for this material, recording the average CFU/ml present at each respective time period. This material observed complete bacterial elimination within a 10 minute exposure period compared to a 99.97% reduction in viable CFUs after three hours for copper metal.

Table 9 summarises the dry contact results for C. albicans.

TABLE 9
Summary of dry contact test results for
original coatings against C. albicans

| | Pathogen: C albicans (ATCC 10231) | | |
|---|---|---|---|
| Rank | Sample No. | Highest Percent Reduction | minutes |
| 1 | 6 - 50% (w/w) | 100% @ 10 min | 100% |
| | Cu—Zn (horizontal) | | |
| 2 | 5 - 75 wt % Cu - | 100% @ 10 min | 100% |
| | 25 wt % Zn | | |
| | (horizontal) | | |
| 3 | 2 - Copper (vertical) | 100% @ 10 min | 91.32% |
| 4 | 1 - Copper (horizontal) | 100% @ 10 min | 100% |
| 5 | 7 - 75 wt % Zn - | 100% @ 10 min | 100% |
| | 25 wt % Cu | | |
| | (horizontal) | | |
| 6 | 3 - Cu—Al-Alumina | 100% @ 15 min | 100% |
| | (horizontal) | | |
| 7 | 4 - Zinc (horizontal) | 100% @ 20 min | 97.11% |
| 8 | Copper metal | 100% @ 1 hour | 85.53% |
| 9 | Stainless steel | 100% @ 3 hours | 83.60% |
| 10 | Galvanised steel | 94.21% @ 20 min | 87.46% |

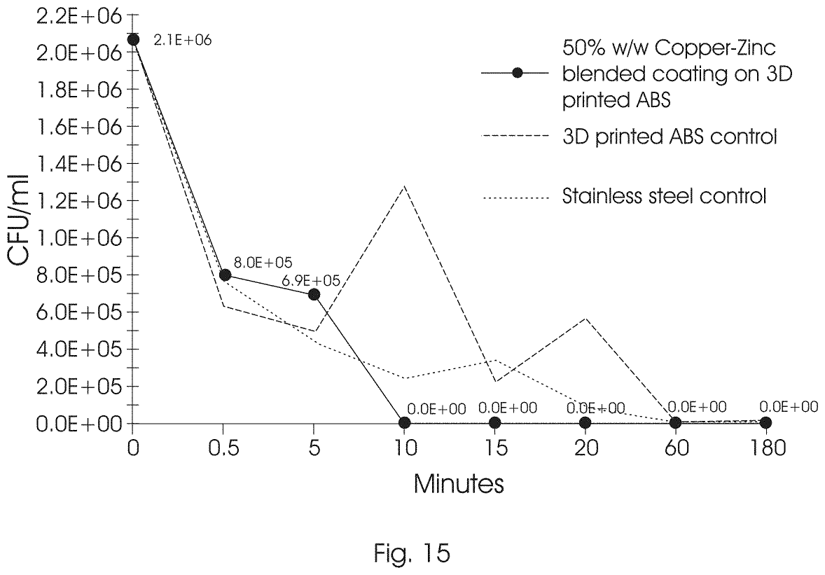

The best performing polymer based material against C. albicans is seen to be a cold spray 50:50 w/w % copper-zinc coating on a 3D printed ABS substrate (horizontal orientation) (Sample No. 6). FIG. 15 depicts the time kill graph for this material, recording the average CFU/ml present at each respective time period. This material observed complete bacterial elimination within a 10 minute exposure period compared to one hour for copper metal.

2) Silver Additive Coatings

The coatings containing a 5 wt % silver were tested for touch-contact antimicrobial activity following the same test procedure as described above. Tables 10, 11 and 12 summarise the dry contact results for the silver additive coatings against S. aureus, P. aeruginosa and C. albicans respectively.

TABLE 10
Summary of dry contact test results for silver
additive coatings against S. aureus

| | Pathogen: S. aureus (ATCC25923) | | |
|---|---|---|---|
| Rank | Sample No. | Highest Percent Reduction | minutes |
| 1 | 9 - 5 wt % Ag - 95 | 100% @ 15 min | 100% |
| | wt % Cu (horizontal) | | |
| 2 | 8 - 5 wt % Ag - 95 | 100% @ 20 min | 99.93% |
| | wt % Cu (vertical) | | |
| 3 | 11 - 5 wt % Ag - 95 | 99.86% @ 3 hours | 95.33% |
| | wt % Zn (horizontal) | | |
| 4 | 10 - 5 wt % Ag - | 99.64% @ 3 hours | 92.96% |
| | 47.5% (w/w) Cu—Zn | | |
| 5 | Copper metal | 98.64% @ 3 hours | 47.75% |
| 6 | Stainless steel | 76.50% @ 3 hours | 54.91% |

TABLE 11
Summary of dry contact test results for silver
additive coatings against P. aeruginosa

| | Pathogen: P. aeruginosa (ATCC27853) | | |
|---|---|---|---|
| Rank | Sample No. | Highest Percent Reduction | minutes |
| 1 | 9 - 5 wt % Ag - 95 | 100% @ 10 min | 100% |
| | wt % Cu (horizontal) | | |
| 2 | 8 - 5 wt % Ag - 95 | 100% @ 10 min | 100% |
| | wt % Cu (vertical) | | |
| 3 | 10 - 5 wt % Ag - | 100% @ 1 hour | 99.46% |
| | 47.5% (w/w) Cu—Zn | | |
| 4 | 11 - 5 wt % Ag - 95 | 100% @ 3 hours | 99.46% |
| | wt % Zn (horizontal) | | |
| 5 | Stainless steel | 95.89% @ 15 min | 95.89% |
| 6 | Copper metal | 99.61% @ 3 hours | 58.48% |

TABLE 12
Summary of dry contact test results for silver
additive coatings against C. albicans

| | Pathogen: C. albicans (ATCC10231) | | |
|---|---|---|---|
| Rank | Sample No. | Highest Percent Reduction | minutes |
| 1 | 10 - 5 wt % Ag - | 100% @ 15 min | 100% |
| | 47.5% (w/w) Cu—Zn | | |
| 2 | 9 - 5 wt % Ag - 95 | 100% @ 15 min | 100% |
| | wt % Cu (horizontal) | | |
| 3 | 11 - 5 wt % Ag - | 100% @ 20 min | 98.49% |
| | 95 wt % Zn | | |
| | (horizontal) | | |
| 4 | 8 - 5 wt % Ag - | 100% @ 20 min | 75.80% |
| | 95 wt % Cu | | |
| | (vertical) | | |
| 5 | Copper metal | 100% @ 3 hours | 45.56% |
| 6 | Stainless steel | 96.98% @ 3 hours | 59.17% |

3) Resistant Microbial Strains

The best performing materials based on both the preceding diffusion testing and dry contact tests were tested under dry, touch-contact antimicrobial susceptibility test conditions. Tables 13, 14 and 15 summarise the dry contact activity of these samples against the resistant microbial strains of: Gentamicin-methicillin-resistant S. aureus (GMRSA), resistant reference P. aeruginosa and clinically resistant C. albicans.

TABLE 13
Summary of dry contact test results for
developed materials against GMRSA

| | GMRSA - ATCC 33592 | | |
|---|---|---|---|
| Rank | Sample | Highest Percent Reduction | minutes |
| 1 | 1 - Copper | 100% @ 10 min | 100% |
| | (horizontal) | | |
| 2 | 6 - 50% (w/w) | 99.22% @ 15 min | 99.22% |
| | Cu—Zn (horizontal) | | |
| 3 | Copper metal | 92.43% @ 1 hour | 81.89% |
| 4 | Stainless steel | 90.13% @ 3 hours | 79.49% |

TABLE 14
Summary of dry contact test results for developed materials
against resistant reference P. aeruginosa

| | Resistant reference P. aeruginosa - DSM 46316 | | |
|---|---|---|---|
| Rank | Sample | Highest Percent Reduction | minutes |
| 1 | 1 - Copper | 100% @ 15 min | 100% |
| | (horizontal) | | |
| 2 | 6 - 50% (w/w) | 97.00% @ 20 min | 89.97% |
| | Cu—Zn | | |
| | (horizontal) | | |
| 3 | Stainless steel | 91.82% @ 15 min | 91.82% |
| 4 | Copper metal | 97.57% @ 15 min | 97.57% |

TABLE 15
Summary of dry contact test results for developed materials
against clinically resistant C. albicans

| | Clinically resistant C. albicans - #4122 | | |
|---|---|---|---|
| Rank | Sample | Highest Percent Reduction | minutes |
| 1 | 1 - Copper | 100% @ 10 min | 100% |
| | (horizontal) | | |
| 2 | 6 - 50% (w/w) | 100% @ 10 min | 100% |
| | Cu—Zn (horizontal) | | |
| 3 | Stainless steel | 100% @ 20 min | 85.57% |
| 4 | Copper metal | 100% @ 1 hour | 48.45% |

All developed materials exhibit antimicrobial activity against the resistant microbial strains and are therefore shown to be effective self-sanitising surfaces for integration into hospital surfaces, instruments and objects. These materials have the potential to combat nosocomial infections and ultimately mitigate the transmission of hospital acquired infections between patients, hospital workers and visitors; thereby reducing the detrimental impact these infections have on hospital environments.

Antimicrobial Susceptibility Test Result Summary:

The copper coatings were seen to be most active in a dry environment; while the zinc performed best in a wet, diffusive environment. Silver was an interesting additive; which showed no antimicrobial activity in its raw powder form, yet as a 5 wt % addition improved copper's antimicrobial efficacy in a wet environment.

Significant dry contact results included 100% microbial elimination against both standard and resistant pathogens for copper cold spray coatings on 3D printed ABS within only 15 minutes, 100% microbial elimination against standard pathogens for a silver-copper blended coating on 3D printed ABS within 15 minutes, and 98% elimination of resistant pathogens for a 50/50 copper-zinc blended coating within 15 minutes. Copper metal, a known antimicrobial agent, was found to exhibit an average maximum percentage reduction of 98.5% in 2 hours 20 minutes against the standard pathogens, and 96.7% in 45 minutes against the resistant strains. Thus, enhanced antimicrobial activity is confirmed for the disclosed cold spray coatings.

Prototype Testing:

Three prototype designs have been devised using the developed and proven antimicrobial cold spray coatings. The three prototypes are: antimicrobial pen covers, antimicrobial smartphone covers, and antimicrobial security access cards. All three have been manufactured via 3D printing and coated with one, or a combination, of the developed cold spray coatings.

Three coating types were tested—covering the broad range of developed materials. These coatings were all applied to 3D printed security access cards. This study was undertaken as part of a final year pharmaceutical microbiology course at The University of the Witwatersrand. The inventors provided support and advice and manufactured the coated cards, but did not conduct the experiment themselves. However, the study does not form part of the gist and claimed invention of this application, but merely serves to verify the usefulness of the invention. The coatings were: a copper coating, a zinc coating and a 50% (w/w) copper-zinc blended coating.

Following a seven day exposure period the cards were swabbed and plated onto blood agar plates. One batch was incubated for 24 hours at 37° C. as part of a bacterial assay, while a second batch were incubated for 48 hours at 25° C. as part of a fungal assay. The viable colony forming units were quantified following incubation. The results are summarised in Table 16.

TABLE 16
Quantification of colony forming

| | | Bacterial | Fungal |
|---|---|---|---|
| Test Samples | | CFUs | CFUs |
| Zinc Coated 3D | Coating | 0 | 6 |
| Printed Access Card | Back of Card | 12 | 107 |
| | (Control Sample) | | |
| Copper Coated 3D | Coating | 0 | 9 |
| Printed Access Card | Back of Card | 103 | 32 |
| | (Control Sample) | | |
| 50% w/w Copper-Zinc Coated | Coating | 2 | 16 |
| 3D Printed Access Card | Back of Card | 8 | 16 |
| | (Control Sample) | | |

| | | |
|---|---|---|
| University (Wits) Access Card (Control Sample) | 5 | 3 |

The standout results from this test include zero bacterial growth for two of the coated cards and significantly reduced fungal growth when compared to the controls for all coated cards. All three coated cards exhibited antimicrobial activity. The coatings do appear to exhibit higher bactericidal activity than fungicidal activity. As an initial pilot study these results are encouraging.

Based on these findings, as well as the laboratory based studies, the developed materials—integrating the technologies of cold spray and 3D printing, together with antimicrobially active metals—have exhibited effective and enhanced antimicrobial activity, with proven applications within the healthcare industry. Considering the lack of biocidal protection afforded by common hospital surfaces and the biocidal activity of the developed materials, these novel coatings may be used to effectively mitigate the transmission of infections from touch-contact surfaces.

It will be appreciated that the above is only one embodiment of the invention and that there may be many variations without departing from the spirit and/or the scope of the invention. It is easily understood from the present application that the particular features of the present invention, as generally described and illustrated in the figures, can be arranged and designed according to a wide variety of different configurations. In this way, the description of the present invention and the related figures are not provided to limit the scope of the invention but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described in a given embodiment can be isolated from the other characteristics of this embodiment unless otherwise expressed.

1.-22. (canceled)

23. A method of manufacturing a coated article, the method including the steps of:
providing a body to be coated, the body having a surface area;
cold spraying an antimicrobial metal powder on at least part of the surface area of the body so as to form an antimicrobial coating on the body;
wherein the body is made from a polymeric material by way of a 3D printing process.

24. The method of claim 23 in which the 3D printing method is fused deposition modelling.

25. The method of claim 23 in which the polymeric material is selected from the group including ABS, PLA, PC or another suitable 3D printable polymer.

26. The method of claim 23 in which the antimicrobial metal powder is selected from the group including copper, silver, zinc, a combination thereof, or a copper-aluminium-alumina blend.

27. The method of claim 25 in which the antimicrobial metal powder is selected from the group including copper, silver, zinc, a combination thereof, or a copper-aluminium-alumina blend.

28. The method of claim 23 in which at least one of an operating pressure, an operating temperature, a nozzle standoff distance, a nozzle transverse speed, a powder feed rate and a step distance is controlled.

29. The method of claim 28 in which the operating pressure is between 0.75 and 0.85 MPa.

30. The method of claim 28 in which the operating temperature is between 100 and 300° C.

31. The method of claim 28 in which the operating temperature is between 190 and 210° C.

32. The method of claim 28 in which the nozzle standoff distance is between 5 and 30 mm.

33. The method of claim 28 in which the nozzle standoff distance is between 5 and 15 mm.

34. The method of claim 28 in which the nozzle transverse speed is between 5 and 25 mm/s.

35. The method of claim 28 in which the nozzle transverse speed is between 10 and 15 mm/s.

36. The method of claim 28 in which the powder feed rate is between 20 and 50%.

37. The method of claim 28 in which the powder feed rate is between 25 and 35%.

38. The method of claim 28 in which the step distance is between 2 and 6 mm.

39. The method of claim 28 in which the step distance is between 4 and 6 mm.

40. A coated article including:
a polymeric body made by way of an additive manufacturing process,
the body having a surface area; and
an antimicrobial coating formed on at least part of the surface area of the polymeric body.

41. The coated article of claim 40 in which the antimicrobial coating is in the form of a metal coating selected from the group including copper, silver, zinc, a combination thereof, or a copper-aluminium-alumina blend.
